(19) United States
(12) Patent Application Publication
(10) Pub. No.: US 2024/0409156 A1
(43) Pub. Date: Dec. 12, 2024

(54) Method and Device for Determining a Filter Output Variable of a Filter for Filtering a Torsion Bar Moment of a Steer-by-Wire Steering System for a Vehicle

(71) Applicant: Robert Bosch GmbH, Stuttgart (DE)

(72) Inventors: Stefan Gruener, Auenwald (DE); Yang Guo, Chemnitz (DE); Bartosz Kaepernick, Murrhardt (DE)

(21) Appl. No.: 18/699,717

(22) PCT Filed: Sep. 19, 2022
(86) PCT No.: PCT/EP2022/075951

§ 371 Date: Apr. 9, 2024

(30) Foreign Application Priority Data
Oct. 11, 2021 (DE) 10 2021 211 432.6

(51) Int. Cl. B62D 6/00

(52) U.S. Cl. CPC B62D 6/008

(57) ABSTRACT

In a device and method for determining a filter output variable of a filter, in particular of a filter for filtering a torsion bar moment of a steer-by-wire steering system of a vehicle, as a function of a filter input variable to be filtered, a predefined filter property of the filter is selected from a plurality of predefined filter properties depending on an input signal characteristic of the filter input variable. The input signal characteristic is determined depending on the filter input variable at a current point in time and at least one previous point in time, and the filter output variable of the filter is determined using the filter property.

### THE PRIOR ART

The invention proceeds from a method and device for determining a filter output variable of a filter, in particular for filtering a torsion bar moment of a steer-by-wire steering system for a vehicle.

In steer-by-wire steering systems, a steering handle receives a direction specification from the driver and also generates a steering feel for a driver of the vehicle by a hand torque adjuster. To generate the steering feel, the hand torque adjuster comprises a motor that outputs a corresponding torque on a rotor shaft that is passed to the steering handle via a transmission and a steering column. The motor is located relatively close to the driver, resulting in a behavior that is noticeable to the driver in terms of acoustics and haptics. This behavior increases to a disturbing and unacceptable level when the motor is controlled by means of very noisy signals. One common approach for treating noisy signals is to employ low-pass characteristic filters to compensate for high-frequency noise levels, but this brings an additional phase shift into the steer-by-wire steering system. Accordingly, a compromise must be made regarding noise filtering and phase delay in order not to degrade stability properties of the steer-by-wire steering system due to the additional phase delay.

Therefore, a filter is desirable that reduces noise without also introducing a large phase delay and maintains a filter error within a defined range.

### DISCLOSURE OF THE INVENTION

Said filter is achieved by a method and device according to the independent claims.

It is provided in the method that for determining a filter output variable of a filter, in particular of a filter for filtering a torsion bar moment of a steer-by-wire steering system of a vehicle, as a function of a filter input variable to be filtered, a predefined filter property of the filter is selected from a plurality of predefined filter properties depending on an input signal characteristic of the filter input variable, whereby the input signal characteristic is determined depending on the filter input variable at a current point in time and at least one previous point in time, whereby the filter output variable is determined by the filter with the filter property. The filter error is affected by the various filter properties of the filter. As a result, it is possible that the filter error be limited to a maximum value. In addition, the filter operates in an operating state favorable to the input signal, thereby reducing phase delay and improving properties of a control loop of the steer-by-wire steering system.

Preferably, it is provided that the plurality of filter properties comprises a first filter property, a second filter property, and a third filter property, whereby, using the first filter property of the filter, the filter output variable is set to a midpoint, in particular a midpoint of a noise band, of the filter input variable; using the second filter property of the filter, the filter is operated as a low-pass filter; using the third filter property of the filter, the filter is operated as a pass element. These filter properties operate the filter in different operating conditions, which makes it possible to compensate for noise in certain scenarios, e.g. a stationary steering wheel. This leads to better acoustic and haptic properties of the steer-by-wire steering system.

It is preferably provided that the predefined filter property of the filter is parameterized by at least one application parameter. Due to the application parameter, it is possible to, e.g., limit the filter error to a specific value or to adjust the individual filter properties. As a result, the filter is able to be adjusted for different operating states or different types of steer-by-wire steering systems accordingly.

It is preferably provided that the at least one application parameter for the predefined filter property characterizes a low-pass filter coefficient and/or a maximum allowable filter error.

It is preferably provided that the input signal characteristic is determined depending on at least one application parameter. As a result, boundaries of the operating conditions and their operating ranges can be adjusted, improving flexibility of the filter.

Preferably the at least one application parameter for the input signal characteristic of the filter input variable characterizes a width of a noise band of the filter input variable, in particular in the form of a quantization noise of the filter input variable and/or a speed of a change in the filter input variable.

Preferably, it is provided that, if the filter input variable for the input signal characteristic: remains within the width of the noise band, then a first operating state of the filter is determined, whereby the first filter property is determined for the filter; exhibits a tendency depart from the width of the noise band, then a second operating state of the filter is determined, whereby the second filter property is determined for the filter; exhibits a tendency to enter the width of the noise band, then a third operating state of the filter is determined, whereby the second filter property is determined for the filter; is outside the width of the noise band and is continuously moving away from it, then a fourth operating state of the filter is determined, whereby the third filter property is determined for the filter; is outside the width of the noise band and begins to approach the noise band, then a fifth operating state of the filter is determined, whereby the second filter property is determined for the filter. As a result, the filter features these operating states and their defined operating ranges, which enables the filter to be implemented efficiently and in a resource-saving manner in an embedded software. Doing so also has a positive impact on a runtime of the filter.

In a vehicle, it can be provided that the torsion bar moment is measured, the filter input variable to be filtered is determined depending on the measured torsion bar moment, and a motor torque for the steer-by-wire steering system is determined depending on the filter output variable and a target torque for the torsion bar moment. As a result, the torsion bar moment regulation of the steer-by-wire steering system is adapted to the situation and improved overall.

The device for determining a filter output variable of a filter, in particular of a filter for filtering a torsion bar moment of a steer-by-wire steering system of a vehicle, as a function of a filter input variable to be filtered, is designed to select a predefined filter property of the filter from a plurality of predefined filter properties depending on an input signal characteristic of the filter input variable, to determine the input signal characteristic depending on the filter input variable at a current point in time and at least one previous point in time and to determine the filter output variable by the filter using the filter property. Due to the various filter properties of the filter, it is possible to influence the filter error. As a result, it is possible to limit the filter error to a maximum value. It is in addition possible that the filter operates in an operating state favorable to the input signal, thereby reducing phase delay and improving properties of a control loop of the steer-by-wire steering system.

Preferably, it is provided that the plurality of filter properties comprises a first filter property, a second filter property, and a third filter property, whereby the device is designed, using the first filter property of the filter, to set the filter output variable to a midpoint, in particular a midpoint of a noise band, of the filter input and, using the second filter property of the filter, to operate the filter as a low-pass filter, and, using the third filter property of the filter, to operate the filter as a pass element. These filter properties make it possible to operate the filter in different operating conditions. It is thereby possible to compensate for noise in certain scenarios, e.g. a stationary steering wheel. This leads to better acoustic and haptic properties of the steer-by-wire steering system.

It is preferably provided that the device is designed to parameterize the predefined filter property of the filter depending on at least one application parameter. Due to the application parameter, it is possible to, e.g., limit the filter error to a specific value or to adjust the individual filter properties. This enables the filter to be adjusted for different operating states or different types of steer-by-wire steering systems accordingly.

It is preferably provided that the at least one application parameter for the predefined filter property characterizes a low-pass filter coefficient and/or a maximum filter error.

It is preferably provided that the device is designed to determine the input signal characteristic depending on at least one application parameter. As a result, boundaries of the operating states and their operating ranges can be adjusted, thus improving the flexibility of the filter.

It is preferably provided that the at least one application parameter for the input signal characteristic of the filter input variable characterizes a width of a noise band of the filter input variable, in particular in the form of a quantization noise of the filter input variable and/or a speed of a change in the filter input variable.

Preferably, it is provided that the device is designed to determine a first operating state of the filter when the filter input variable for the input signal characteristic remains within the width of the noise band, and to determine the first filter property for the filter, to determine a second operating state when showing a tendency to depart from the width of the noise band, and to determine the second filter property for the filter, and to determine a third operating state of the filter when showing a tendency to enter the width of the noise band, and to determine the second filter property for the filter outside the width of the noise band and continuously moving away from it, and to determine a fourth operating state of the filter, and to determine the third filter property for the filter outside the width of the noise band and beginning to approach the noise band, to determine a fifth operating state of the filter, and to determine the second filter property for the filter. As a result, the filter has these operating states and their defined operating ranges. This enables the filter to be implemented efficiently and in a resource-saving manner in an embedded software. This also has a positive impact on a runtime of the filter.

The device can improve a steer-by-wire function in a vehicle. In this case, the vehicle comprises the device, the device being designed to measure the torsion bar moment, to determine the filter input variable to be filtered depending on the measured torsion bar moment, and to determine a motor torque for the steer-by-wire steering system depending on the filter output variable and a target torsion bar moment.

Further advantageous embodiments follow from the description and the drawings hereinafter. The drawings show:

FIG. 1 a schematic illustration of a filter,

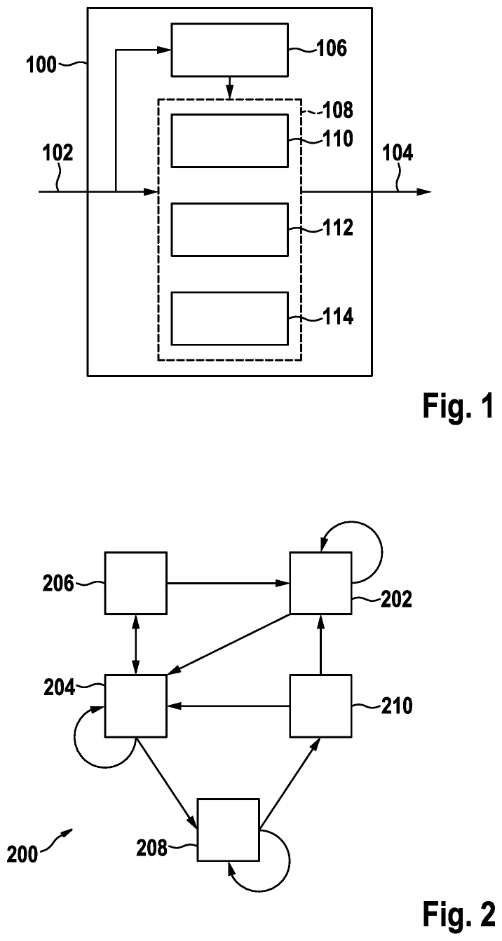

FIG. 2 a schematic illustration of a state graph of the filter,

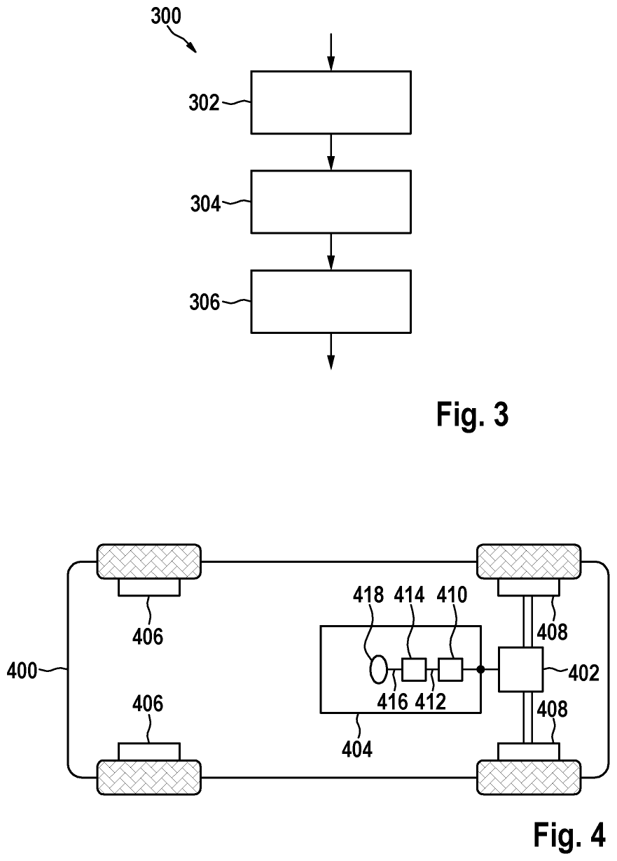

FIG. 3 a flowchart of a method for determining a filter output variable of the filter,

FIG. 4 a schematic illustration of a vehicle,

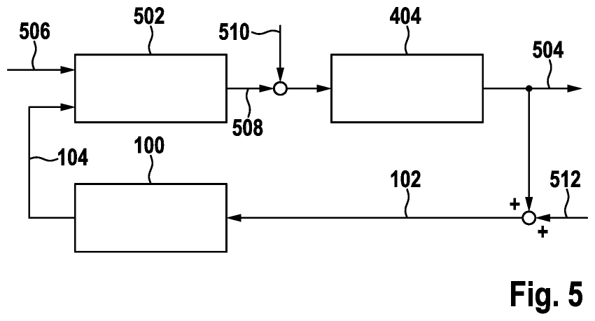

FIG. 5 a control loop.

FIG. 1 shows a filter 100 in a schematic view. A filter input variable 102 is provided to the filter 100. The filter 100 determines a filter output variable 104 depending on the filter input variable 102. The filter input variable 102 is also fed to an evaluation device 106. In the example, the filter 100 comprises the evaluation device 106. It can be provided that the evaluation device 106 is arranged as a device removed from the filter 100. The filter 100 further has a plurality of filter properties 108. The plurality of filter properties 108 includes a first filter property 110, a second filter property 112, and a third filter property 114. It can be provided that the plurality of filter properties 108 include a lower or higher number of filter properties. The evaluation device 106 determines, depending on an input signal characteristic of the filter input variable 102 from the plurality of filter properties 108, a filter property used to process the filter input variable 102 by the filter 100. The filter output variable 104 is determined by the filter 100 depending on the filter input variable 102 and the particular filter property of the filter 100. The input signal characteristic is determined by the evaluation device 106 depending on the filter input variable 102 at a current time and at least one previous time.

The filter 100 is operated using the first filter property 110 if the filter input variable 102 alternates by a mean value and between two quantization values. The upper and lower quantization values are limits for a noise band and define a width of the noise band. The first filter property 110, in the event that the filter input variable 102 is within the noise band, causes the filter output variable 104 to be set at the mean value of the noise band. The filter 100 thus causes, using the first filter property 110, the filter output variable 104 to remain at a piecewise constant value and not have the alternating behavior of the filter input variable 102.

The filter 100 is operated using the second filter property 112 when the filter input variable 102 has dynamic behavior. The filter input variable 102 is still close to the mean value of the noise band, but exhibits a tendency to depart from or enter the noise band. The second filter property 112 in this case causes the filter 100 to exhibit a first-order low-pass behavior.

The filter 100 is operated using the third filter property 114 if the filter input variable 102 continuously moves away from the noise band and exhibits a highly dynamic behavior. The third filter property 114 in this case causes the filter 100 to exhibit a behavior of a pass element. The filter 100, using the third filter property 114, causes the filter input variable 102 to be switched directly to the filter input variable 102.

It can also be provided that the plurality of filter properties 108 include further properties of signal-processing structures or functions, such as a band pass characteristic, an inverter characteristic, or variously configured filter properties of the same category.

FIG. 2 shows a state graph 200 for the filter 100 filter in a schematic view. The state graph includes operating states 202, 204, 206, 208, and 210. These operating states 202 to 210 are represented by the filter 100 and the plurality of filter properties 108.

In the first operating state 202, the filter input signal 102 remains within the noise band and the filter 100 is operated using the first filter property 110. The filter output variable 104 is thus set at the mean value of the noise band.

In the second operating state 204, the filter input signal 102 exhibits a tendency to depart from the noise band and the filter 100 operates using the second filter property 112. The filter output variable 104 is therefore the low-pass filtered filter input variable 102.

In the third operating state 206, the filter input signal 102 exhibits a tendency to enter the noise band and the filter 100 operates using the second filter property 112. The filter output variable 104 is therefore the low-pass filtered filter input variable 102.

In the fourth operating state 208, the filter input variable 102 is outside the noise band and constantly moves away from it, so the filter 100 operates using the third filter property 114. The filter input signal 102 is thus switched directly to the filter output variable 104 and thus no filtering takes place.

In the fifth operating state 210, the filter input signal 102 no longer exhibits the dynamic behavior of the fourth operating state 206 and begins to approach the noise band, so the filter 100 operates using the second filter property 112. The filter output variable 104 is therefore the low-pass filtered filter input variable 102.

Depending on the operating state, the mean value of the noise band is updated accordingly, so the noise band moves with a signal progression of the filter input variable 102. This update takes place in operating states 206, 208, and 210. The state graph 200 shows the following properties of the filter 100. In the first operating state 202, a filter error e=|in−out|that is subtracted from the amount of the filter output variable 104 calculated from the filter input variable 102 moves within the noise band. The filter error e is defined in the first operating state 202 by the width of the noise band. In the example, the first operating state 202 can be achieved, in particular, only from the third operating state 206 and the fifth operating state 210, whereby the mean value of the noise band is updated to a current variable of the filter output variable 104, As a result, the input signal 102 can remain in the middle of the noise band in the first operating state 202 as far as possible. It can be provided that the width of the noise band is used as the application parameter of the filter 100. In the fourth operating state 208, the filter input variable 102 is set to the filter output variable 104, so the filter error is e=0. In the second operating state 204, in the third operating state 206, and in the fifth operating state 210, additional testing of a deviation of filter input variable 102 and filter output variable 104 is performed. If this deviation is greater than a defined maximum filter error eₘ, then the filter output variable 104 is adjusted to a defined maximum filter error eₘ. By having a corresponding selected coefficient of the low pass filter property of the second filter property 112, it is possible that the filter error e remains within the maximum filter error eₘ. In this case, the deviation does not need to be tested.

The following is an example of a design and algorithm of the filter 100. This design is based on the state graph in FIG. 2 and operating states 202 to 210, and shows, among other things, the transition conditions of the individual operating states 202 to 210, as well as an implementation of the filter properties 110 to 114. The design can, e.g., be achieved using embedded software.

### Variables and Parameters:

Filter input variable 102:
1. u(k), u(k−1): the current or previous sampling value of the filter input variable 102 to be filtered.

Filter output variable 104:
1. y(k), y(k−1): the current or previous sampling value of the filter output variable 104.

Internal defined application parameters:
1. ∈: the width of the noise band
2. β∈ (1,3): application parameter for a slowly varying filter input variable
3. α ∈ (0,1): first-order low-pass filter coefficient
4. eₘ: the maximum filter error allowed
5. d: application parameter that is greater than a maximum difference of the filter input variable in a sampling step.

Internal variables:
1. m(k), m(k−1): the current or previous mean value of the noise band.
2. D(k), D(k−1): the distance from the current or previous sampling value of the filter input variable 102 to the previous mean value of the noise band.
   Therefore, D(k)=u(k)−m(k−1) and D(k−1)=u(k−1)−m(k−1).
      The transition conditions in the respective operating states 202 to 210 and the events triggered accordingly:

Operating state 202:
1. Conditions: |D(k−1)|<∈ and |D(k)|<∈
2. Events: y(k)=y(k−1), then m(k)=m(k−1)

Operating state 204:
1. Conditions: (|D(k−1)|≤∈ and |D(k)|≥∈) or |D(k)|>∈ and |D(k−1)|≤β*∈ and ∥D(k)|−|D(k−1)∥≤∈)
2. Events: y(k)=a*u(k)+(1-a)*y(k−1)+sgn(y(k−1)−u(k))*min(eₘ−(1−a)*|y(k−1)−u(k)|.), where sgn(.) is the sign function and min(.) assumes the smaller value of the two expressions, then m(k)=m(k−1)

Operating state 206:
1. Conditions: |D(k−1)|>∈ and |D(k)|<∈
2. Events: y(k)=a*u(k)+(1−a)*y(k−1)+sgn(y(k−1)−u(k))*min(eₘ−(1−a)*|y(k−1)−u(k)|.0), then m(k)=y(k)

Operating state 208
1. Conditions: (|D(k−1)|≤|D(k)| and |D(k−1)|>β*∈) or (|D(k−1)|>∈ and |D(k)|−|D(k−1)|>∈)
2. Events: y(k)=u(k), then m(k)=u(k)−sgn(D(k))*d

Operating state 210:
1. Conditions: (|D(k−1)|>|D(k)| and |D(k)|≥∈ and |D(k−1)|>β*E) or (|D(k−1)|−|D(k)|>∈ and |D(k)|≥∈)
2. Events: y(k)=a*u(k)+(1-a)*y(k−1)+sgn(y(k−1)−u(k))*min(eₘ−(1−a)*|y(k−1)−u(k)|.0), then m(k)=y(k).

The filter 100 is parameterized using the application parameters ∈, β, a, eₘ and d. The application parameters of the width of the noise band E and the application parameters β are used as parameters for determining the input signal characteristic of the filter input variable 102. The application parameter a is used as a coefficient of the low pass filter property of the second filter property 112, thereby parameterizing this filter property. The application parameter of eₘ the maximum filter error is also used as an application parameter of the second filter property 112. The application parameter d is used as the parameter of the third filter property 114 to update the mean value of the noise band. The filter 100 is adapted to different scenarios and areas of application using the application parameters.

FIG. 3 shows a flow diagram 300 of a method for determining a filter output 104 of a filter 100. In step 302, the filter 100 is provided with the filter input variable 102 and the input signal characteristic is determined.

The input signal characteristic is determined depending on the filter input variable 102 at a current point in time and at least one previous point in time.

It can be provided that the input signal characteristic is determined for a speed of a change in the filter input variable 102, e.g. depending on at least one application parameter, such as the width of the noise band, E and/or an application parameter.

In step 304, depending on the input signal characteristic of the filter input variable 102, a predefined filter property of the filter 100 is selected from the plurality of predefined filter properties 108.

Preferably, the plurality of the filter properties 108 include the first filter property 110, the second filter property 112, and the third filter property 114, whereby the first filter property 110 of the filter 100 sets the filter output variable 104 at the midpoint, particularly at the midpoint of a noise band, of the filter input variable 102. Using the second filter property 112, the filter 100 is operated as a low-pass filter. Using the third filter property 114, the filter 100 is operated as a pass element.

Preferably, the predefined filter property of the filter 100 is parameterized by at least one application parameter. It can be provided that the at least one application parameter is a low pass filter coefficient and/or a maximum allowable filter error.

It can be provided that, if the filter input variable 102 for the input signal characteristic remains in the width of the noise band, then the first operating state 202 of the filter 100 is determined, whereby the filter 100 operates using the first filter property 110. If the filter input variable 102 for the input signal characteristic exhibits a tendency to depart from the width of the noise band, then the second operating state 204 of the filter 100 is determined, whereby the filter is operated using the second filter property 112. If the filter input variable 102 for the input signal characteristic exhibits a tendency to enter the width of the noise band, then the third operating state 206 of the filter 100 is determined, whereby with the filter is operated using the second filter property 112. If the filter input variable 102 is outside the width of the noise band for the input signal characteristic and continuously moves away from it, then the fourth operating state 208 of the filter 100 is determined, whereby the filter operates using the third filter property 114. If the filter input variable 102 is outside the width of the noise band for the input signal characteristic and begins to approach the noise band, then the fifth operating state 210 of the filter 100 is determined, whereby the filter 100 is operated using the second filter property 112.

In step 306, the filter output variable 104 is determined using the filter 100 having the predefined filter property.

For example, the filter 100 is employed in a steer-by-wire steering system for filtering a torsion bar moment as the filter input variable 102.

In this example, the filter 100 is designed as a torsion bar moment filter in the context of hand torque control of a steer-by-wire steering system. The filter 100 is, e.g., employed to smooth or filter a quantization-noise torsion bar moment.

In FIG. 4, a vehicle 400 is shown with a steer-by-wire steering system comprising a steering system 402 and a hand torque adjuster 404.

In the example, the vehicle 400 comprises two rear wheels 406 and two front wheels 408. In the example, the rear wheels 406 cannot be steered. The front wheels 408 in the example can be steered by means of the steering system 402.

In addition to the front wheels 408, or instead of the front wheels 408, the rear wheels 406 can also be steered by means of the steering system.

The hand torque adjuster 404 takes direction specifications from a driver and creates a steering feel for the driver. To generate the steering feel, the hand torque adjuster 404 comprises a motor 410 that outputs a corresponding torque on a rotor shaft 412 that is then passed to steering handle 418 via a transmission 414 and a rotating rod 416. An exemplary steering wheel is illustrated as a steering handle 418.

Due to the fact that the motor 410 is relatively close to the driver, this can result in a behavior that is noticeable to the driver in terms of acoustics and haptics. This behavior can even increase to a disturbing and unacceptable level when the motor 410 is controlled by means of very noisy signals.

Using the filter 100 and the filtering method, the acoustic and haptic behavior is significantly improved without significantly degrading the remaining control quality.

FIG. 5 shows a control loop with a controller 502 and the filter 100 for controlling the hand torque adjuster 404. Control using the controller 502 is based on an actual moment 504 (in the example, the torsion bar moment on the rotating rod 416) and a predefined target moment 506 (in the example, the desired torsion bar moment).

The controller 502 determines a suitable motor torque 508 to control the target torque 504 even in the presence of interferences 510, e.g. driver engagement or model deviations. As shown in FIG. 5, the filter input signal 102 is based on the actual moment 504 and basically includes noise 512.

In the example, quantization noise is specifically considered. While a higher-value measurement technique can reduce noise influence, it can never fully compensate. The controller 502 itself could be designed to account for the influence of the noise 512. However, this typically means that the control properties are negatively influenced based on other criteria, e.g. performance, so a conflict of goals can arise.

One common practice for treating noisy signals is to employ appropriate filters. A conventional filter features a low-pass characteristic to compensate for the high-frequency noise components, but brings an additional phase shift into the system. A further compromise must thus be made with regard to noise filtering and phase delay so as not to significantly degrade the stability properties of the system by the additional phase.

In order to significantly reduce the quantization noise without introducing a large phase delay and also to limit a filter error in a defined range, the case-dependent filter 100 is used. The filter output variable 104 in the example is a feedback signal for the controller 502. The controller 502 uses this feedback signal and the target torque 506 to determine the motor torque 508.

Typically, when the steering wheel of the steer-by-wire steering system is at rest. In other words, if the torsion bar moment does not change much, then the filter 100 is operated using the first filter property 110 when the torsion bar moment, i.e., the filter input variable 102, alternates around a mean value and between two quantization values. As the characteristic of the torsion bar moment changes, so does the input characteristic on the filter 100. The filter properties are thereby switched based on the input signal characteristic as described. The filter output variable 104 is thereby adapted to the situation.

1. A method for determining a filter output variable of a filter as a function of a filter input variable to be filtered, the method comprising:
selecting a predefined filter property of the filter from a plurality of predefined filter properties depending on an input signal characteristic of the filter input variable,
determining the input signal characteristic depending on the filter input variable at a current point in time and at least one previous point in time; and
determining the filter output variable of the filter using the predefined filter property.

2. The method according to claim 1, wherein:
the plurality of predefined filter properties comprises a first filter property, a second filter property, and a third filter property, and the determining of the filter output variable includes:
when the first filter property is selected as the predefined filter property, the filter output variable sets the filter input variable at a midpoint of a noise band;
when the second filter property is selected as the predefined filter property, the filter is operated as a low-pass filter; and
when the third filter property is selected as the predefined filter property, the filter is operated as a pass element.

3. The method according to claim 1, further comprising:
parameterizing the predefined filter property of the filter depending on at least one application parameter.

4. The method according to claim 3, wherein the at least one application parameter for the predefined filter property characterizes a low-pass filter coefficient and/or a maximum allowable filter error.

5. The method according to claim 2, wherein the input signal characteristic is determined depending on at least one application parameter.

6. The method according to claim 5, wherein the at least one application parameter for the input signal characteristic of the filter input variable characterizes a width of a noise band of the filter input variable.

7. The method according to claim 6, wherein, when the filter input variable for the input signal characteristic:
remains in the width of the noise band, then a first operating state of the filter is determined, and the first filter property for the filter is selected;
exhibits a tendency to depart from the width of the noise band, then a second operating state of the filter is determined, and the second filter property is selected for the filter;
exhibits a tendency to enter the width of the noise band, then a third operating state of the filter is determined, wherein the second filter property is selected for the filter;
is outside the width of the noise band and continuously moving away from the noise band, then a fourth operating state of the filter is determined, wherein the third filter property is selected for the filter;
is outside the width of the noise band and begins to approach the noise band, then a fifth operating state of the filter is determined, wherein the second filter property is selected for the filter.

8. The method according to claim 17, further comprising:
measuring the torsion bar moments;
determining the filter input variable to be filtered depending on the measured torsion bar moment; and
determining a motor torque for the steer-by-wire steering system depending on the filter output variable and a target torque for the torsion bar moment.

9. A device for determining a filter output variable of a filter, depending on a filter input variable to be filtered, wherein the device is designed:
to select a predefined filter property of the filter depending on an input signal characteristic of the filter input variable from a plurality of predefined filter properties;
to determine the input signal characteristic depending on the filter input variable at a current and at least a previous time; and
to determine the filter output variable through the filter with the predefined filter property.

10. The device according to claim 9, wherein:
the plurality of filter properties comprises a first filter property, a second filter property, and a third filter property, and the device is designed such that the determining of the filter output variable includes:
when the first filter property of the filter is selected as the predefined filter property, the filter output variable is set to a midpoint of a noise band of the filter inlet variable;
when the second filter property of the filter is selected as the predefined filter property, the filter is operated as a low-pass filter;
when the third filter property is selected as the predefined filter property, the filter is operated as a pass element.

11. The device according to claim 9, wherein the device is designed to parameterize the predefined filter property of the filter depending on at least one application parameter.

12. The device according to claim 11, wherein the at least one application parameter for the predefined filter property characterizes a low-pass filter coefficient and/or a maximum filter error.

13. The device according to claim 10, wherein the device is designed to determine the input signal characteristic depending on at least one application parameter.

14. The device according to claim 13, wherein the at least one application parameter for the input signal characteristic of the filter input variable characterizes a width of a noise band of the filter input variable.

15. The device according to claim 14, wherein the device is designed such that, when the filter input variable for the input signal characteristic:
remains within the width of the noise band, a first operating state of the filter is determined and the first filter property is selected for the filter;
exhibits a tendency to depart from the width of the noise band, a second operating state of the filter is determined and the second filter property is selected for the filter;
exhibits a tendency to enter the width of the noise band, a third operating state of the filter; is determined and the second filter property s selected for the filter;
is outside the width of the noise band and continuously moves away from the noise band, a fourth operating state of the filter is determined and the third filter property is selected for the filter;
is outside the width of the noise band and begins to approach the noise band, a fifth operating state of the filter is determined and the second filter property is selected for the filter.

16. A vehicle comprising:
a steer-by-wire steering system having a torsion bar moment; and
the device of claim 9, wherein the device is designed to measure the torsion bar moment, to determine the filter input variable to be filtered depending on the measured torsion bar moment, and to determine a motor torque for the steer-by-wire steering system depending on the filter output variable and a target torque for the torsion bar moment.

17. The method according to claim 1, wherein the filter is configured to filter a torsion bar moment of a steer-by-wire steering system of a vehicle.

18. The method according to claim 6, wherein the at least one application parameter for the input signal characteristic of the filter input variable characterizes the width of the noise band in the form of a quantization noise of the filter input variable and/or a speed of a change in the filter input variable.

19. The device according to claim 9, wherein the filter is configured to filter a torsion bar moment of a steer-by-wire steering system of a vehicle.

20. The device according to claim 14, wherein the at least one application parameter for the input signal characteristic of the filter input variable characterizes the width of the noise band in the form of a quantization noise of the filter input variable and/or a speed of a change in the filter input variable.
